(19) United States
(12) Patent Application Publication
(10) Pub. No.: US 2012/0299434 A1
(43) Pub. Date: Nov. 29, 2012

(54) STATOR OF A PERMANENTLY EXCITED ROTATING ELECTRIC MACHINE

(75) Inventors: Ulrich Hartmann, Berlin (DE); Axel Möhle, Berlin (DE)

(73) Assignee: SIEMENS AKTIENGESELLSCHAFT, MUNCHEN (DE)

(21) Appl. No.: 13/576,878

(22) PCT Filed: Dec. 30, 2010
(86) PCT No.: PCT/EP10/70911

§ 371 Date: Aug. 2, 2012

(30) Foreign Application Priority Data
Feb. 5, 2010 (DE) 10 2010 001 620.9

(51) Int. Cl. H02K 1/16

(52) U.S. Cl. 310/216.074

(57) ABSTRACT

A stator of a permanently excited rotating electric machine has a plurality of segments abutting each other at radially and axially extending segment boundaries. Each segment has a plurality of radially projecting teeth of uniform width and grooves extending in the axial direction and alternatingly arranged in a peripheral direction of the stator. Abutting segments touch each other at the segment boundaries such that an outer tooth of one segment touches an outer tooth of an abutting segment, wherein a sum of the widths of the two teeth touching each other at the corresponding segment boundary is greater than the uniform width of at least a majority of the plurality of teeth of a segment that are not arranged directly at a segment boundary of that segment. Detent moments and/or oscillating moments occurring in a permanently excited rotating electric machine can thereby reduced.

The invention relates to a stator of a permanently excited rotating electric machine.

With a permanently excited rotating electric machine, such as for instance a permanently excited generator or a permanently excited electric motor, the detent moments are in particular a critical design variable during idling of the electric machine. The amplitude of the detent moments must be kept to a minimum here. Furthermore, the oscillating moments which occur under load must also be kept to a minimum.

Particularly with directly driven, permanently excited wind power generators, the detent moments, which occur during idling, and the oscillating moments, which occur during operation of the wind power generator, are to be kept to a minimum.

The following methods are nowadays essentially used to minimize the oscillating moment:
Slanting of the permanent magnets disposed in the rotor of the electric machine,
Slanting of the electrical conductor in the stator of the electric machine,
Displacement of the permanent magnets of the rotor from the pole axis.

The afore-cited known methods are however complicated in terms of manufacture.

It is the object of the invention to reduce detent and/or oscillating moments occurring in a permanently excited rotating electric machine.

This object is achieved by a stator of a permanently excited rotating electric machine, wherein the stator has several segments disposed adjacent to one another in the peripheral direction of the stator, wherein the segments comprise teeth and grooves extending in the axial direction of the stator, wherein segments which are immediately adjacent to one another in each instance touch at a segment boundary, wherein the teeth of the segments immediately adjacent to one another are disposed such that a tooth of the one segment touches a tooth of the segment immediately adjacent to the one segment at the segment boundary, wherein the sum of the widths of the two teeth touching at the respective segment boundary is greater than the uniform width of the plurality of teeth which are not disposed immediately at a segment boundary or of all teeth which are not disposed immediately at a segment boundary.

Advantageous embodiments of the invention result from the dependent claims.

It has proven advantageous if the sum of the widths of the two teeth touching at the respective segment boundary is smaller than or equal to twice the uniform width of the plurality of teeth, which are not disposed immediately at a segment boundary or of all teeth which are not disposed immediately at a segment boundary. If the widths of the two teeth touching at the respective segment boundary are in the specified range, the detent and/or oscillating moments are reduced particularly significantly.

It has also proven advantageous if a minimum number of the teeth, which are not disposed immediately adjacent at a segment boundary, has a uniform width which is greater than the uniform width of the plurality of teeth, which are not disposed immediately at a segment boundary. This measure further reduces the detent and/or oscillating moments.

It has also proven advantageous if the minimum number of teeth, which are not disposed immediately at a segment boundary, has a uniform width, which is smaller than or equal to twice the uniform width of the plurality of teeth which are not disposed immediately at a segment boundary. If the width of the minimum number of teeth which are not disposed immediately at a segment boundary has a uniform width which is in the specified range, the detent and/or oscillating moments are reduced particularly significantly.

Furthermore, it has proven advantageous if the widths of the two teeth touching at the respective segment boundary are of equal size, since the segments are then embodied to be particularly mechanically stable at the segment boundary.

The permanently excited rotating electric machine can in this way be embodied as a generator or electric motor for instance, wherein the generator can be embodied in particular as a wind power generator and in particular as a directly driven (the wind wheel is directly connected to the wind power generator without interconnected gearing) wind power generator.

An exemplary embodiment of the invention is shown in the drawing and is explained in more detail below, in which:

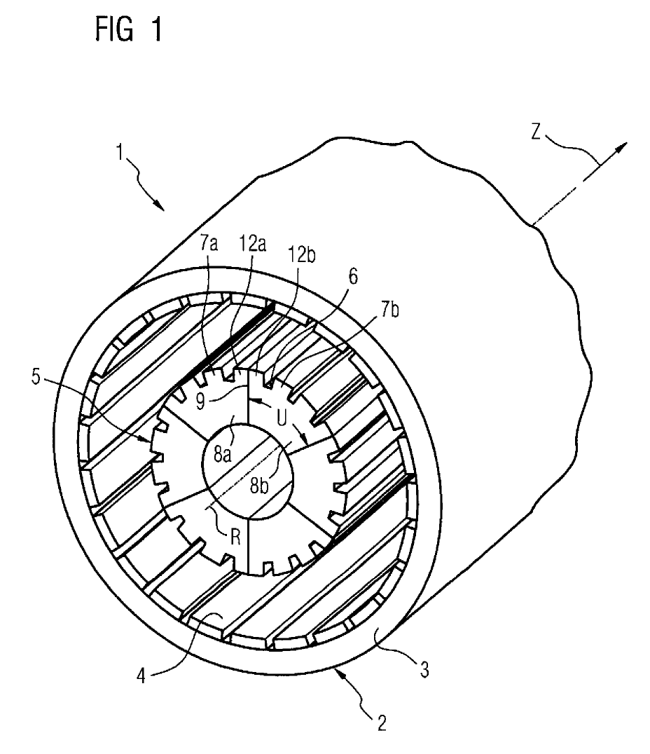

FIG. 1 shows a schematic view of an inventive permanently excited rotating electric machine and

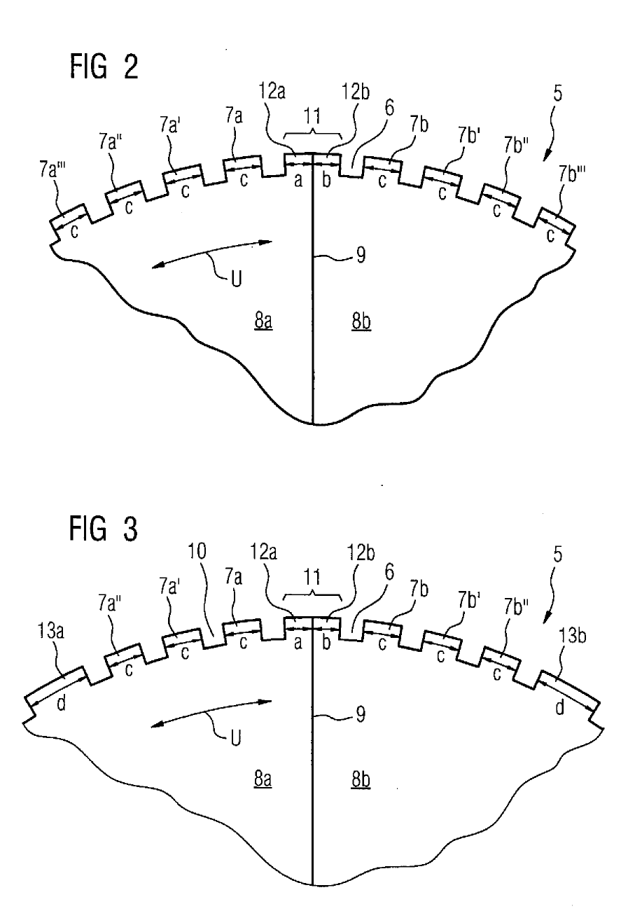

FIG. 2 shows a schematic detailed view of a cutout of an inventive stator of the machine within the scope of an embodiment of the invention.

FIG. 3 shows a schematic detailed view of a cutout of an inventive stator of the machine within the scope of a further embodiment of the invention.

FIG. 1 shows an inventive permanently excited rotating electric machine 1 in the form of a schematic perspective representation. The machine 1 is in this way embodied as a generator and in particular as a wind power generator within the scope of the exemplary embodiment. It should be noted at this point that for the sake of clarity, only the elements of the machine 1 which are essential to the understanding of the invention are shown in FIG. 1.

The machine 1 comprises a rotor 2, which is disposed so as to be rotatable about an axis of rotation R of the machine 1. Here the rotor 2 includes all elements of the machine 1 which are disposed so as to be rotatable about the rotor axis R. The rotor 2 has a rotor yoke 3 on which permanent magnets are arranged, wherein for the sake of clarity, only a permanent magnet 4 is provided with a reference character in FIG. 1. During operation of the machine 1, the rotor 2 rotates within the scope of the exemplary embodiment about a stator 5 disposed centrally in the machine 1 and at rest compared with the surroundings of the machine 1. Since the rotor 2 is disposed around the stator 5, such a machine is also referred to as external rotor in technical terms. Since the rotor 1 has permanent magnets, which permanently generate a magnetic field for operating the machine 1, such a machine is also referred to in technical terms as permanently excited or as a permanent magnet-excited machine. Since the machine 1 has a rotor 2 rotating about an axis of rotation R during operation of the machine 1, such a machine is also referred to as rotating electric machine.

The inventive stator 5 comprises several segments disposed adjacent to one another in the peripheral direction U of the stator 5. Within the scope of the exemplary embodiment, the stator 5 in this case has six segments, wherein for the sake of clarity only the segments 8a and 8b are provided with a reference character. The segments comprise teeth and grooves extending in the axial direction Z of the stator 5, wherein for the sake of clarity, only the teeth 7a, 12a, 7b, 12b and the groove 6 are provided with a reference character in FIG. 1. In this way segments immediately adjacent to one another in each instance touch at a segment boundary, wherein for the sake of clarity only the segment boundary 9 at which the segments 8a and 8b touch is provided with a reference character. Each segment consists of metal sheets disposed one behind the other in the axial direction Z. The individual metal sheets of a segment are in this way generally provided with an electric insulation layer, such as for instance a lacquered layer. During assembly of the stator 5, the segments are disposed adjacent to one another in the peripheral direction U and connected to one another resulting in the tubular stator 5 shown.

The teeth and grooves of the segments are produced by a corresponding molding of the form of the metal sheet. The electrical windings of the stator extend around the teeth into the grooves, wherein for the sake of clarity and since they are not essential to the understanding of the invention, the windings are not shown.

With commercially available permanently excited rotating electric machines, the widths of the individual teeth of the stator 5 are identical here. In accordance with the invention, detent and oscillating moments produced during operation of the machine 1 are reduced here by a target widening of specific teeth compared with the remaining teeth of the stator.

It should be noted again at this point that FIG. 1 is a schematic representation in which for instance the width, number and dimensions of the teeth, grooves and permanent magnets, as well as the size of the air gap disposed between the stator and rotor do not correspond with the reality for instance.

FIG. 2 shows a cutout of the segment 8a and of the segment 8b immediately adjacent to the segment 8a in the form of a schematic sectional view. The two segments 8a and 8b touch at the segment boundary 9. In the cutout shown, segment 8a has the teeth 12a, 7a, 7a′, 7a″ and 7a″′ and segment 8b has the teeth 12b, 7b, 7b′, 7b″ and 7b″′. It should be noted at this point that in reality a segment can have hundreds of teeth and grooves for instance, so that only a small cutout of the segments is shown in FIG. 2.

In accordance with the invention, the teeth of the segments immediately adjacent to one another are disposed such that a tooth of the one segment touches a tooth of the segment immediately adjacent to the segment at the respective segment boundary. Within the scope of the exemplary embodiment, the teeth of the segments 8a and 8b disposed immediately adjacent to one another are disposed such that a tooth of the one segment 8a touches a tooth of the segment 8b immediately adjacent to the segment 8a at the segment boundary 9 in each instance. Within the scope of the exemplary embodiment, these are the teeth 12a and 12b which touch one another at the segment boundary 9. No division of the stator therefore takes place within a groove in accordance with the invention.

For the sake of clarity, only a groove 6 is provided with a reference character in FIG. 2. A segment, as already mentioned, does not end in the peripheral direction U at a groove, i.e. the segment boundary 9 does not lie within a groove. The tooth 12a has a width a and the tooth 12b has a width b. The teeth, which are not disposed immediately adjacent to a segment boundary, i.e. in the exemplary embodiment according to FIG. 2, the teeth 7a, 7a′, 7a″, 7a″′, 7b, 7b′ 7b″ and 7b″′ shown, have a uniform width c, i.e. they are all the same width. In accordance with the invention, the sum (a+b) of the widths a and b, of the teeth 12a, 12b touching at the respective segment boundary is greater than the uniform width c of all teeth (7a, 7a′, 7a″, 7a″′, 7b, 7b′, 7b″, 7b″′), which are not disposed immediately at a segment boundary 9.

In other words the following applies

a+b>c

The overall tooth 11 formed from both teeth 12a and 12b touching at the segment boundary 9 therefore has a larger width, in particular significantly larger width than the uniform width c of the teeth which are not disposed immediately at a segment boundary 9. The detent and oscillating moments are significantly reduced by the inventive measure. Contrary to the prior art, no arbitrary tooth is therefore divided by the segment boundary so that the partial teeth thus developing, such as in the prior art, by disregarding a minimum air gap possibly developing between the two sub teeth, are not as wide as an undivided tooth.

The sum (a+b) of the widths a, b of the two teeth 12a and 12b touching at the respective segment boundary is preferably embodied to be smaller than or equal to twice the uniform width c of all teeth, which are not disposed immediately at a segment boundary, i.e. the following applies

c<a+b≦2c

If the sum (a+b) of the widths a, b is selected in this range, the detent and oscillating moments are reduced particularly significantly.

A high mechanical stability of the segments is achieved if the widths a and b of the two teeth touching at the respective segment boundary are of equal size, i.e. a=b applies.

Within the scope of a uniform production, it is advantageous here if all teeth of a segment and thus of the stator have a uniform width, i.e. the following applies:

a=b=c

This measure also achieves a particularly high mechanical stability of the stator and of the individual segments, since no teeth are present at the segment boundary, which only still comprise part of the width of the teeth, which are not disposed at the segment boundary.

FIG. 3 shows a further embodiment of the invention, wherein in FIG. 3 identical elements are provided with identical reference characters as in FIG. 2, The embodiment according to FIG. 3 corresponds to the embodiment according to FIG. 2 in terms of function and design, wherein with the embodiment according to FIG. 3, a minimum number of teeth, which are not disposed immediately at the segment boundary, have a larger width than the uniform width of the plurality of teeth which are not disposed immediately at a segment boundary. Within the scope of the exemplary embodiment, the teeth 13a and 13b herewith have a width b which is greater than the uniform width c of the plurality of teeth 7a, 7a′, 7a″, 7b, 7b′, 7b″, which are not disposed immediately at a segment boundary, in other words the following applies:

d>c

The sum (a+b) of the widths a and b of the two teeth touching at the respective segment boundary 9 is greater in this case than the uniform width c of the plurality 7a, 7a′, 7a″, 7b, 7b′, 7b″ which are not disposed immediately at a segment boundary.

A particularly good suppression of detent and oscillating moments is achieved if the minimum number of teeth (13a, 13b), which are not disposed immediately at a segment boundary, have a uniform width b, which is smaller than or equal to twice the uniform width c of the plurality of teeth which are not disposed immediately at a segment boundary, i.e. the following applies:

c<d≦2c

It is naturally also advantageous in this embodiment of the invention for the widths of the two teeth touching at the respective segment boundary to be of equal size, i.e. the following applies:

a=b

In order to achieve particularly high stability, it may preferably also apply to the width of the teeth:

a=b=c

i.e., the width of the teeth, which are disposed immediately at a segment boundary, corresponds to the width of the plurality of teeth, which are not disposed immediately at a segment boundary.

The statements made above within the scope of the description relating to FIG. 2 and FIG. 3 in respect of the two segments 8a and 8b also apply accordingly to the remaining segments of the stator 5 which are not shown in FIG. 2 and FIG. 3.

Complicated measures such as pole offset or groove slanting can, in manufacturing terms, be dispensed with using the invention.

On account of the higher rigidity and on account of the tooth arranged at the segment boundary, the thus embodied segments are simpler to manufacture and to assemble than with a commercially available stator, in which all teeth including the overall tooth formed from the two teeth touching at the respective segment boundary have a uniform width (a+b=c=d).

1-7. (canceled)

8. A stator of a permanently excited rotating electric machine, comprising:
a plurality of segments abutting each other at radially and axially extending segment boundaries, each segment comprising a plurality of radially projecting teeth having a uniform width and grooves extending in the axial direction and alternatingly arranged in a peripheral direction of the stator, wherein abutting segments touch each other at the segment boundaries such that an outer tooth of one segment touches an outer tooth of an abutting segment, wherein a sum of the widths of the two teeth touching each other at the corresponding segment boundary is greater than the uniform width of at least a majority of the plurality of teeth of a segment that are not arranged directly at a segment boundary of that segment.

9. The stator of claim 8, wherein the majority of the plurality of teeth includes all teeth that are not arranged directly at the segment boundary.

10. The stator of claim 8, wherein the sum of the widths of the two teeth touching each other at the corresponding segment boundary is smaller than or equal to twice the uniform width of at least the majority of the plurality of teeth of a segment that are not arranged directly at a segment boundary of that segment or of all teeth that are not arranged directly at the segment boundary of that segment.

11. The stator of claim 8, wherein at least one tooth that is not arranged directly at the segment boundary has a uniform width which is greater than the uniform width of the majority of the teeth.

12. The stator of claim 8, wherein at least one tooth that is not arranged directly at the segment boundary has a uniform width which is smaller than or equal to twice the uniform width of the majority of the teeth of a segment that are not arranged directly at a segment boundary of that segment

13. The stator of claim 8, wherein the two teeth touching each other at the corresponding segment boundary have equal widths.

14. A permanently excited rotating electric machine, wherein the machine is embodied as a generator or electric motor, the electric machine comprising:
a rotor, and
a stator comprising a plurality of segments abutting each other at radially and axially extending segment boundaries, each segment comprising a plurality of radially projecting teeth having a uniform width and grooves extending in the axial direction and alternatingly arranged in a peripheral direction of the stator, wherein abutting segments touch each other at the segment boundaries such that an outer tooth of one segment touches an outer tooth of an abutting segment, wherein a sum of the widths of the two teeth touching each other at the corresponding segment boundary is greater than the uniform width of at least a majority of the plurality of teeth of a segment that are not arranged directly at a segment boundary of that segment.

15. The permanently excited rotating electric machine of claim 14, wherein the machine is embodied as a wind power generator.
